(19) United States
(12) Patent Application Publication
(10) Pub. No.: US 2026/0295338 A1
(43) Pub. Date: Oct. 1, 2026

(54) HUMANOID ROBOT AND CONTROL METHOD FOR HUMANOID ROBOT

(71) Applicant: CANON KABUSHIKI KAISHA, Tokyo (JP)

(72) Inventor: MASASHI SHIDARE, Chiba (JP)

(21) Appl. No.: 19/573,406

(22) Filed: Mar. 20, 2026

(30) Foreign Application Priority Data
Mar. 27, 2025 (JP) 2025-052828

(51) Int. Cl. A63B 24/00; G09B 19/00

(52) U.S. Cl. CPC A63B 24/0075; A63B 24/0062; G09B 19/003; A63B 2230/015; A63B 2230/755

(57) ABSTRACT

A humanoid robot includes at least one processor operating to acquire user information, generate an exercise menu based on the user information, perform a demonstration of an exercise included in the exercise menu, capture an image of a state in which a user is performing the demonstrated exercise, and output a result of the exercise performed by the user to a terminal owned by the user.

### BACKGROUND

### Field of the Technology

The present disclosure relates to a humanoid robot and a control method for the humanoid robot.

### Description of the Related Art

Conventionally, there is a game that causes a player to perform fitness movements. For example, Japanese Patent Laid-Open No. 2023-174979 describes a technique of displaying a model of a fitness movement on a screen and causing a user to perform a movement imitating the model.

In exercises such as fitness movements, stretching, and calisthenics, an ideal posture is required in order to sufficiently obtain effects of the exercises, and a method for conveying the ideal posture to a user is important. However, a two-dimensional display on a screen has a limitation on the information that can be conveyed.

### SUMMARY

An aspect of the present disclosure is directed to providing a robot capable of effectively conveying an ideal posture in exercise to a user.

According to an aspect of the present disclosure, a humanoid robot includes at least one processor operating to acquire user information, generate an exercise menu based on the user information, perform a demonstration of an exercise included in the exercise menu, capture an image of a state in which a user is performing the demonstrated exercise, and output a result of the exercise performed by the user to a terminal owned by the user.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of a humanoid robot according to an embodiment.

FIG. 2 is a flowchart illustrating an example of an operation of the humanoid robot according to the embodiment.

### DESCRIPTION OF THE EMBODIMENTS

Hereinafter, an embodiment of the present disclosure will be described in detail with reference to the attached drawings. The following embodiments do not limit the present disclosure set forth in the claims, and not all combinations of features described in the embodiments are necessarily essential to the solution of the present disclosure. In addition, a plurality of features may be optionally combined. Further, in the attached drawings, identical or similar components are denoted by identical reference numerals, and redundant description will be omitted.

First, an information processing system and the like according to the present embodiment will be described.

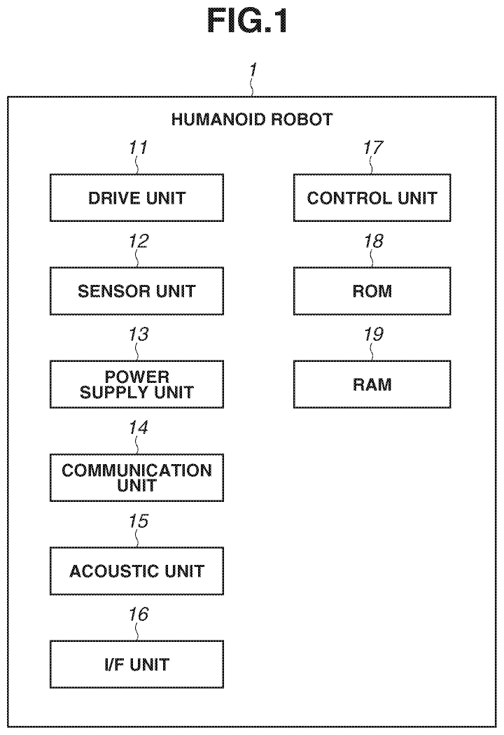

FIG. 1 is a block diagram illustrating an example of a hardware configuration of a humanoid robot 1 according to the present embodiment. The humanoid robot 1 includes a drive unit 11, a sensor unit 12, a power supply unit 13, a communication unit 14, an acoustic unit 15, an interface (I/F) unit 16, a control unit 17, a read only memory (ROM) 18, and a random access memory (RAM) 19. The humanoid robot 1 may include all of the components described above, may include only a part of the components described above, or may include a component not described above.

The drive unit 11 is provided to move the humanoid robot 1. A motor and an actuator are disposed in a joint portion. For example, a servo motor enables precise position control and realizes smooth motion. A range of motion of each joint may imitate a range of motion of a human joint.

The sensor unit 12 is used to acquire environment information. In particular, the sensor unit 12 includes a camera for capturing an image of a user and a balance sensor (such as a gyroscope and an accelerometer) for posture control of the humanoid robot 1. Further, the sensor unit 12 desirably includes an auditory sensor for recognizing an utterance made by a user.

As a visual sensor, for example, stereo vision and depth recognition may be enabled by using a plurality of cameras. As an auditory sensor, for example, a directional microphone or an array microphone is used, and sound source localization and a noise canceling function may be provided.

The power supply unit 13 may be supplied with power from an outlet or the like, but a rechargeable battery can be employed. The battery may be removable, or the battery may be charged in a state in which the battery is built into the humanoid robot 1.

The communication unit 14 is a communication device for enabling the robot to connect to a network and exchange information in real time. As a communication method, Wi-Fi®, Bluetooth®, a 5G module, and the like can be employed. This configuration enables seamless data exchange with a cloud service or another device, thereby supporting execution of complex tasks.

The acoustic unit 15 includes a speaker and a sound processor, and outputs music and provides instructions, guidance, and the like to a user by voice. An interface (I/F) unit 16 is an interface for allowing a user to operate the humanoid robot 1, and can employ a touch screen, a physical button, or the like.

The control unit 17 is a processor for controlling the entirety of the humanoid robot 1 and for executing calculations for performing various functions described below. The control unit 17 reads a program recorded in the ROM 18 and executes processing of the program. The control unit 17 may load, in the RAM 19, a program acquired via the communication unit 14, and may execute the program. The RAM 19 is also used to temporarily store information and the like used when the control unit 17 performs various types of processing.

Programs that are stored and which control the motion of the humanoid robot 1 according to the present embodiment include, for example, a motion analysis program, an instruction program, a feedback program, a motion program, a perception program, and a dialogue program.

The motion analysis program analyzes user motion in real time and evaluates whether a posture of the user is accurate. The evaluation is performed by image comparison between the photographed posture of the user and the ideal posture stored by the humanoid robot. The ideal posture may be stored on the server, and the posture of the user photographed by the humanoid robot may be transmitted to the server for evaluation on the server. The instruction program generates appropriate instructions for stretching or strength training based on user information (such as a height, a weight, and an exercise purpose, daily movement data, and the like). The instruction program further generates customization in accordance with a physical condition of the user and a training goal of the user. The feedback program monitors the user motion and provides feedback when improvement of a stretching posture or the like is required.

The motion program is a program that controls the motion of the robot. The motion program includes, for example, a motion planning module, a motion control module, and a feedback control module. The motion planning module calculates an optimal motion path in accordance with a purpose of the robot, and the motion control module adjusts, in real time, a position and a speed of a joint. The feedback control module finely adjusts a motion based on information from a sensor, thereby improving accuracy. This configuration enables the robot to accurately perform a complex motion.

The perception program is a program that processes data obtained from a sensor and assisting understanding of an environment. The perception program may include, for example, an image processing module and a speech recognition module. The image processing module performs object recognition and motion analysis, thereby enhancing visual understanding of the robot. The speech recognition module converts a natural-language voice into text in real time, thereby providing a basis for dialogue.

The dialogue program is a program for realizing natural dialogue with a human. The dialogue program may include, for example, a natural language processing module, an emotion recognition module, and a speech synthesis module. The natural language processing module includes an algorithm for analyzing input text and understanding a meaning of the input text. The emotion recognition module estimates an emotion from a tone of a voice and a facial expression and adjusts dialogue content. The speech synthesis module generates an utterance of the robot and enables natural and friendly communication.

Although the exterior is not illustrated, a frame functioning as a skeleton of the humanoid robot can be formed of a lightweight durable material. For example, carbon fiber, an aluminum alloy, or the like is commonly used, achieving both reduced weight and strength. The exterior of the humanoid robot may be covered with a flexible material such as silicone or polyurethane to imitate human skin to provide a realistic appearance. This configuration improves tactile interaction and enables impact absorption.

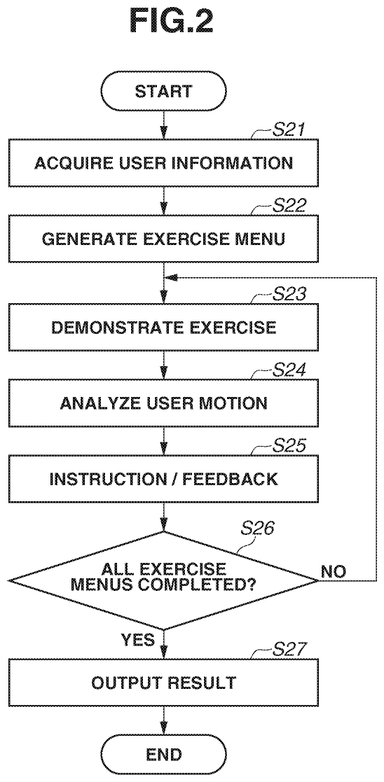

FIG. 2 is a flowchart illustrating an example of an operation of the humanoid robot 1 according to the present embodiment. The procedure of FIG. 2 starts, for example, when the humanoid robot 1 is activated, or when a user inputs, to the humanoid robot 1, an indication that the user will start exercise (stretching, strength training, or the like).

In step S21, the humanoid robot 1 acquires user information. The user information can include, for example, basic information such as age, gender, height, and weight of a user. The user information may further include an exercise purpose (health maintenance, flexibility improvement, strength improvement, and the like), a target body part (a body part for which fat is a concern, a body part to be trained, and the like), a health condition (a medical history, presence or absence of an injury), an exercise time, an intensity, and a target calorie consumption. The user information may further include other requests, such as a request for outdoor activity, a request to use specific equipment. This configuration enables generation (or creation) of an exercise proposal further reflecting a preference of the user.

In acquiring the user information, the humanoid robot 1 may accept input from the user via the I/F unit 16 or by voice-based dialogue, and may read information stored in the RAM 19. The humanoid robot 1 may acquire information input to an application of a smartphone, a tablet terminal, or the like of the user via the communication unit 14.

Further, the humanoid robot 1 may capture, as the user information, an image of a state of a daily life of the user, may estimate a standing posture, a sitting posture, a painful body part, a stiff body part, or the like, and may reflect an estimation result in an exercise menu generated in step S22.

In step S22, the humanoid robot 1 generates an exercise menu (details, an order, and the like of stretching, strength training, and the like) based on the user information. In step S23, the humanoid robot 1 performs a demonstration of an exercise.

In step S24, the humanoid robot 1 captures an image of a state in which the user is exercising, and analyzes the motion of the user. For example, the humanoid robot 1 measures a position of the body of the user and a speed of motion of the body of the user, and evaluates posture accuracy. The analysis enables determination of whether the user is training with appropriate form. For example, in a squat, the humanoid robot 1 evaluates an angle of a knee and a position of a back, and confirms whether the form is correct.

In step S25, the humanoid robot 1 provides instruction to the user through voice and through motion of the humanoid robot 1, and indicates points for improvement. Voice-based instruction emphasizes points to which attention is to be paid while the user is performing the exercise, and prompts the user to make real-time correction. A motion of the humanoid robot 1 indicates a specific improvement method and a reference motion, thereby enabling visual understanding by the user.

For example, specific advice such as “Bend the knees a little more” or “Keep the back straight” is provided, and the user can correct a motion based on the advice. The feedback serves a role of maintaining motivation of the user and improving training quality.

In step S26, the humanoid robot 1 determines whether all exercises included in the exercise menu generated in step S22 have ended. If all exercises included in the exercise menu have ended (YES in step S26), the processing proceeds to step S27. If an exercise that has not yet ended remains in the exercise menu (NO in step S26), the processing returns to step S23 and starts instruction for the next exercise.

In step S27, the humanoid robot 1 reports a training result to the user and provides a proposal for next training. The training result may include calorie consumption and exercise time, and may include, as a score, an analysis result in step S24. The training result may include, for example, a result generated based on motion analysis data about the user and indicating an achieved goal and a point to be improved. For example, the training result may include an indication of improvement in a specific movement and advice regarding a new training goal.

The humanoid robot 1 may provide a specific proposal for next training. This configuration is expected to enable the user to understand progress and to continuously maintain motivation. The humanoid robot 1 may adjust the content of the next session based on the information and may prepare to provide an optimal plan in accordance with individual needs.

The report of the training result may be provided by the humanoid robot 1 by voice, may be displayed by providing the humanoid robot 1 with a display unit (display), or may be output to an application of a smartphone or the like of the user via the communication unit 14.

The procedure described with reference to FIG. 2 may be configured such that a part of processing is performed by an external server, or a part of processing is performed by an application of a terminal such as a smartphone of the user. In that case, information required for the processing and a processing result are input and output via the communication unit 14. With this configuration, a cost of a control unit 17 and the like to be mounted in the humanoid robot 1 can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., an application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a central processing unit (CPU), a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), a digital versatile disc (DVD), or a Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-052828, filed Mar. 27, 2025, which is hereby incorporated by reference herein in its entirety.

What is claimed is:

1. A humanoid robot comprising:
at least one processor operating to:
acquire user information;
generate an exercise menu based on the user information;
perform a demonstration of an exercise included in the exercise menu;
capture an image of a state in which a user is performing the demonstrated exercise; and
output a result of the exercise performed by the user to a terminal owned by the user.

2. The humanoid robot according to claim 1, wherein the user information includes one or more of an age of the user, a gender of the user, a height of the user, a weight of the user, an exercise purpose, an exercise target body part, a health condition, an exercise time, an intensity, and a target calorie consumption.

3. The humanoid robot according to claim 1, wherein the at least one processor operates to determine, by image comparison between a posture of the user and an appropriate posture, whether the user is performing the demonstrated exercise in the appropriate posture.

4. The humanoid robot according to claim 3, wherein the at least one processor operates to indicate, to the user, a point for posture improvement based on a result of the determination.

5. The humanoid robot according to claim 4, wherein the at least one processor operates to indicate the point for improvement by causing the humanoid robot to perform at least by a motion indicative of the point for improvement.

6. The humanoid robot according to claim 1, wherein the result of the exercise includes at least one of calorie consumption, an exercise time, an achieved goal, and a proposal for next exercise.

7. A control method for a humanoid robot, the control method comprising:
acquiring user information;
generating an exercise menu based on the user information;
performing a demonstration of an exercise included in the exercise menu;
capturing an image of a state in which a user is performing the demonstrated exercise; and
outputting a result of the exercise performed by the user to a terminal owned by the user.

8. The control method for a humanoid robot according to claim 7, wherein the user information includes one or more of an age of the user, a gender of the user, a height of the user, a weight of the user, an exercise purpose, an exercise target body part, a health condition, an exercise time, an intensity, and a target calorie consumption.

9. The control method for a humanoid robot according to claim 7, further comprising determining, by image comparison between a posture of the user and an appropriate posture, whether the user is performing the demonstrated exercise in the appropriate posture.

10. The control method for a humanoid robot according to claim 9, further comprising indicating, to the user, a point for posture improvement based on a result of the determining.

11. The control method for a humanoid robot according to claim 10, further comprising indicating the point for improvement by causing the humanoid robot to perform at least by a motion indicative of the point for improvement.

12. The control method for a humanoid robot according to claim 7, wherein the result of exercise includes at least one of calorie consumption, an exercise time, an achieved goal, and a proposal for next exercise.
